(19) United States
(12) Patent Application Publication
(10) Pub. No.: US 2010/0208422 A1
(43) Pub. Date: Aug. 19, 2010

(54) DETACHABLE MOUNTING ASSEMBLY FOR MOTHERBOARD

(75) Inventors: TZU-WEI TAI, Taipei (TW); Ya-chyi Chou, Taipei (TW); Hsing-cheng Liu, Taipei (TW); Yen-ting Liu, Taipei (TW); Po-yang Shih, Taipei (TW); Cheng-han Chang, Taipei (TW); Ting-kuo Kao, Taipei (TW)

Correspondence Address: Allen, Dyer, Doppelt, Milbrath & Gilchrist, P.A., Suite 1401, 255 South Orange Avenue, Orlando, FL, 32801-3460, US

(73) Assignee: ASUSTeK Computer Inc., Taipei City (TW)

(21) Appl. No.: 12/701,815

(22) Filed: Feb. 8, 2010

(30) Foreign Application Priority Data
Feb. 13, 2009 (TW) 098104768

(51) Int. Cl. G06F 1/20; G06F 1/16

(52) U.S. Cl. 361/679.31; 361/679.02; 361/679.54

(57) ABSTRACT

The invention discloses a detachable mounting assembly for a motherboard. The assembly includes an electronic component; a carrier for carrying the electronic component and having a first portion; a base including a recess which is located at a predetermined position corresponding to the carrier on the motherboard and a second portion corresponding to the first portion, magnetically coupled to the first position. The carrier further includes an inserting structure cooperating with the recess to locate the carrier in the predetermined position.

### FIELD OF THE INVENTION

The invention relates to an assembly and, more particularly, to a detachable mounting assembly for a motherboard.

### BACKGROUND OF THE INVENTION

To a motherboard structure designed for mass production, whatever the motherboard is used in, such as a computer, a server, a workstation or other systems or subsystems, mostly, all the components are soldered on the motherboard using the surface mounted technology (SMT). The electronic components disposed on the motherboard via the SMT are hard to be replaced by the user. With the progress of the information industry, the period for the innovation of a control chip is much shorter than a normal lifespan of the motherboard, and peripheral devices such as a memory module or an interface card also need to be upgraded continuously to meet the requirement of the software operation. Thus, a player of the information products or a lead user often needs to replace important components on the motherboard by himself or herself, and thus replaceable bases come into being in succession.

To the current replaceable components in the market such as the CPU or the controller, the replacing mode thereof is not suitable for the limited space and the operating environment in the equipment case. Besides the space limitation and the difficulty in performing complex replacing steps, the user may discharge the static electricity in the human body to the fragile electronic components easily when the component on the motherboard is replaced, which may damage the electronic components. In addition, it may be hard for the user to apply the force and place the components in the correct position accurately due to the visual obstructing or the operating environment limitation when the user replaces the components on the motherboard.

Therefore, the invention provides a detachable mounting assembly for a motherboard, which is illustrated hereinbelow.

### SUMMARY OF THE INVENTION

The invention discloses a detachable assembly to allow an electronic component or an interface card device on a motherboard in a computer case to be detached and replaced easily. A user may detach a carrier assembled on the motherboard without tools, and after replacing or checking the electronic component or the interface card therein, he or she may assemble the carrier back to the correct position easily. Due to the function of a magnet, the carrier is fixed and electrically communicates with the motherboard. In addition, via the structure thereof, the carrier may cover the inner electronic component or the interface card device carried by the carrier to prevent the user from damaging the electronic component on the motherboard due to the unintended touch when the electronic component or the interface card device is replaced. In addition, the simple operating mode also reduces the chances for the user to damage other electronic components on the motherboard unintendedly.

According to the conception mentioned above, the invention discloses a detachable mounting assembly for a motherboard. The assembly includes an electronic component, a carrier, a base and a second portion. The carrier is used for carrying the electronic component and has a first portion. The base is located on the motherboard and includes a recess located at a predetermined position corresponding to the carrier. The second portion is disposed on the base, corresponding to the first portion, and magnetically coupled to the first portion.

Preferably, the carrier of the assembly in the invention further includes an inserting structure cooperating with the recess to locate the carrier in the predetermined position.

Preferably, the electronic component of the assembly in the invention is an integrated circuit (IC) component in a thin-type no-lead package state.

Preferably, the carrier of the assembly in the invention further has a mounting structure for attaching or detaching the electronic component.

Preferably, the carrier of the assembly in the invention further has a transmitting circuit which may be connected to the motherboard via the base to allow the electronic component to work via the transmitting circuit.

Preferably, the carrier of the assembly in the invention further includes a thermal conducting mechanism for transmitting the thermal generated by the electronic component.

Preferably, the electronic component of the assembly in the invention is an interface card or a memory module.

Preferably, the carrier of the assembly in the invention further has a peripheral component interconnect (PCT), PCI-Express (PCIe), PCI-Extended (PCI-x) or dual-inline-memory-modules (DIMM) slot.

Preferably, at least one of the first portion and the second portion in the assembly of the invention includes a magnet.

Preferably, the carrier in the assembly of the invention further has a metal outer case for covering the functional device.

Preferably, the second portion in the assembly of the invention is located in the recess.

These and other features, aspects and advantages of the present handy and detachably assembly or device will become better understood with regard to the following description, appended claims, and accompanying drawings.

### BRIEF DESCRIPTION OF THE DRAWINGS

FIG. 1 is a schematic diagram showing the structure of a detachable mounting assembly for a motherboard in an embodiment of the invention;

FIG. 2 is a schematic diagram showing the structure of a detachable mounting assembly for a motherboard in another embodiment of the invention; and

FIG. 3 is a schematic diagram showing the structure of a detachable mounting assembly for a motherboard in still another embodiment of the invention.

### DETAILED DESCRIPTION OF THE EMBODIMENTS

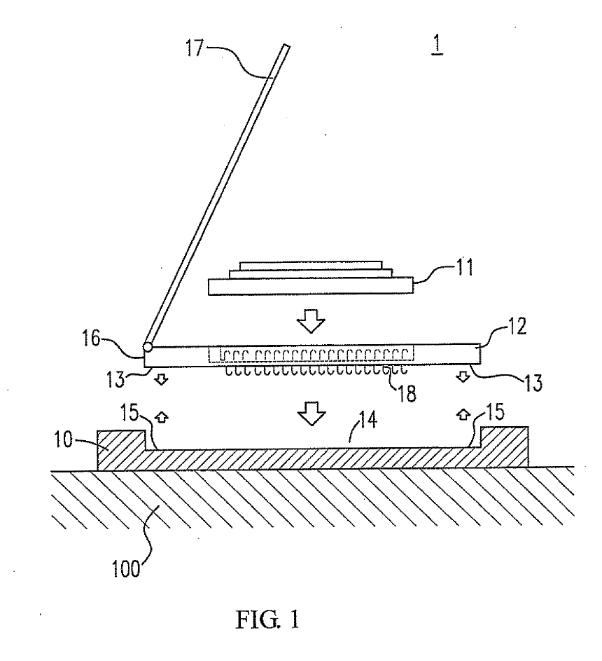

FIG. 1 is a schematic diagram showing the structure of a detachable mounting assembly on a motherboard in an embodiment of the invention. The assembly 1 is located on the motherboard 100, and it includes an electronic component 11, a carrier 12 and a base 10. The base 10 includes a recess 14. The electronic component 11 is usually an integrated circuit (IC) component in a thin-type no-lead package state (such as quad flat no-lead package (QFN), pin grid array (PGA), land grid array (LGA), dual flat pack no-lead package (DFN) and so on) such as a CPU or other control chips. The carrier 12 further has a mounting structure 17 for attaching or detaching the electronic component 11. The mounting structure 17 whose functions are similar with a cover or a latch fixes the electronic component 11 in the carrier 12, as shown in FIG. 1. A transmitting circuit 18 disposed at the bottom of the carrier 12 may be connected to the base 10. Via the transmitting circuit 18 and the base 10, contact endpoints (not shown) at the bottom of the electronic component 11 are connected to the circuit system of the motherboard 100 using a conventional interface to allow the electronic component 11 to work normally.

As shown in FIG. 1, a recess 14 is formed on the base 10 at a predetermined position for the carrier 12, and the carrier 12 further has an inserting structure 16 at the portion for entering the recess 14. The size of the inserting structure 16 corresponds to that of the recess 14 to allow the carrier 12 to be located in the predetermined position easily. When the carrier 12 carrying the electronic component 11 is disposed in the recess 14, pin-type electronic signal connectors of the transmitting circuit 18 at the bottom of the carrier 12 may respectively contact the contact endpoints (not shown) in the recess 14. On the contrary, to achieve the same effect, flat contact endpoints may be disposed at the bottom of the transmitting circuit 18, and pin-type electronic signal connectors may be disposed in the recess. The recess 14 guides the carrier 12 to the position to allow each pin-type electronic signal connector to be aligned with the corresponding contact endpoint.

To make the carrier 12 located in the recess 14 stably and make each pin-type electronic signal connector electrically communicate with the corresponding contact endpoint effectively, the carrier 12 has at least a first portion 13. In addition, a second portion 15 is disposed at the top of the base 10 corresponding to the first portion 13. The first portion 13 and the second portion 15 are magnetically coupled to each other, and that is, at least one of the first portion 13 and the second portion 15 has a magnet. As shown in FIG. 1, the second portion 15 is usually disposed in the recess 14, but it also may be located at other positions according to the structure design of the carrier 12.

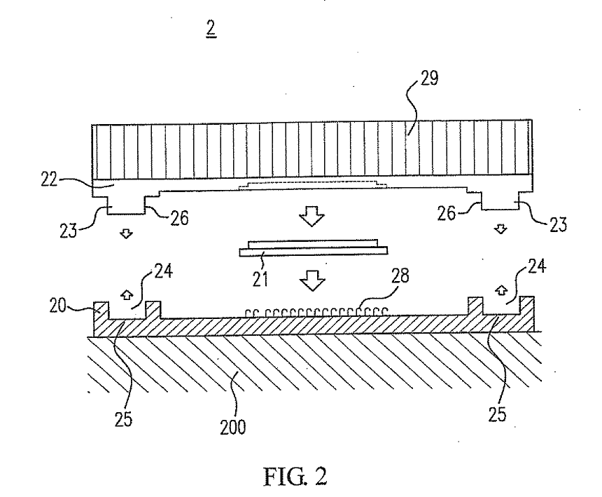

FIG. 2 is a schematic diagram showing the structure of the detachable mounting assembly according to another embodiment in the invention. The assembly 2 is located on the motherboard 200, and it includes an electronic component 21, a carrier 22 and a base 20. The base 20 includes at least a recess 24. The electronic component 21 is usually an IC component in a thin-type no-lead package state (such as the QFN, PGA, LGA, DFN and so on) such as the CPU or other control chips. The carrier 22 further has a thermal conducting mechanism 29 such as a heat sink or a heat pipe to conduct thermal generated by the electronic component 21. As shown in FIG. 2, the top of the electronic component 21 usually closely contacts the bottom of the carrier 22, and thus the thermal generated by the electronic component 21 is emitted via the thermal conducting mechanism 29.

As shown in FIG. 2, at least a recess 24 is formed on the base 20 at the predetermined position for the carrier 22, and the carrier 22 further has an inserting structure 26 at the corresponding portion for entering the recess 24. The size of the inserting structure 26 corresponds to that of the recess 24 to allow the carrier 22 to be located in the predetermined position easily. Although there are two recesses 24 corresponding to two inserting structures 26 in FIG. 2, a skilled person in the art should know the disposing mode when the numbers of the inserting structures 26 and the recesses 24 are different. When the carrier 22 carrying the electronic component 21 is disposed in the recess 24, the contact endpoints (not shown) at the bottom of the electronic component 21 electrically communicate with the multiple corresponding pin-type electronic signal connectors 28 disposed in the recess 24. The recess 24 guides the carrier 22 to the position to align the pin-type electronic signal connectors 28 with the corresponding contact endpoints. Multiple pin-type electronic signal connectors 28 disposed in the recess 24 are further connected to the circuit system of the motherboard 200 via the base 20 to make the electronic component 21 work normally when the computer is booted.

Similarly, to make the carrier 22 located at the recess 24 stably and each pin-type electronic signal connector 28 effectively electrically communicate with the corresponding contact endpoint, the carrier 22 has at least a first portion 23. In addition, a second portion 25 is disposed at the top of the base 20 corresponding to the first portion 23. Each first portion 23 and the second portion 25 are magnetically coupled to each other, and that is, at least one of a first portion 23 and a second portion 25 has a magnet. As shown in FIG. 2, the second portion 25 is usually disposed in the recess 24, but it also may be disposed at other positions according to the structure design cooperating with the carrier 22.

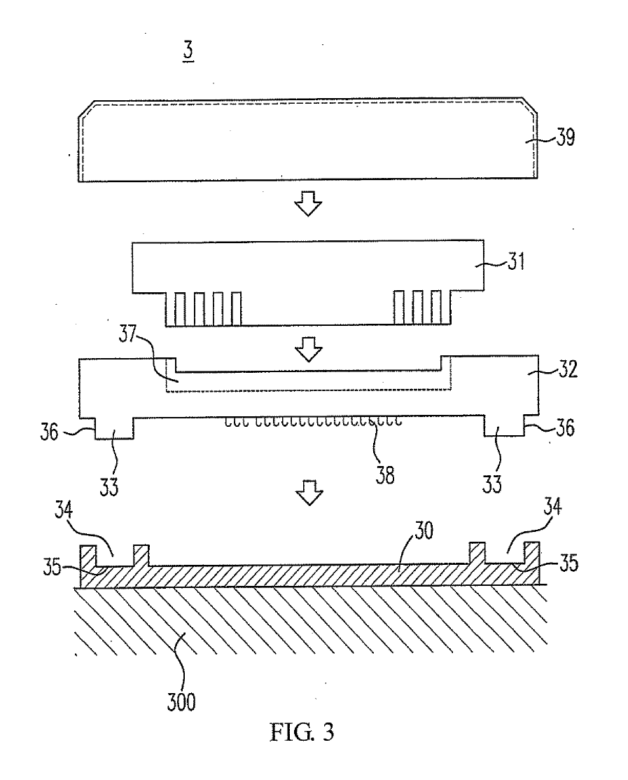

FIG. 3 is a schematic diagram showing the structure of the handy and detachably assembly for the motherboard according to still another embodiment of the invention. The assembly 3 is located on the motherboard 300, and it includes a functional device 31, a carrier 32 and a base 30. The base 30 includes at least a recess 34. The functional device 31 is an interface card or a memory module. The carrier 32 further has a metal outer case 39 to allow the user to hold and cover the functional device to prevent the electronic component in the functional device 31 from being damaged due to the unintended touch by the user. The metal outer case 39 also have functions of conducting static electricity and the electromagnetic radiation shield. To cooperate with the pins of the functional device 31 which may be golden fingers or other types of pins, the carrier 32 has a slot 37, and the specification of the slot 37 may be PCI, PCIe, PCI-X, DMII or other conventional specification. A transmitting circuit 38 disposed at the bottom of the carrier 32 may be connected to the motherboard 300 via the base 30 to make the functional device 31 electrically connected to the circuit system of the motherboard 300 using the conventional interface via the carrier 32 to make the functional device 31 work normally.

At least a recess 34 is disposed at the base 30 at the predetermined position for the carrier 32, and the carrier further has an inserting structure 36 at the corresponding portion for entering the recess 34. The size of the inserting structure 36 corresponds to that of the recess 34 to allow the carrier 32 to be disposed in the predetermined position easily. Although two recesses 34 corresponding to two inserting structures 36 are taken as an example in FIG. 3, a skilled person in the art should know the disposing mode when the numbers of inserting structures 36 and the recesses 34 are different. When the carrier 32 carrying the functional device 31 is disposed in the recess 34, the pin-type electronic signal connectors of the transmitting circuit 38 at the bottom of the carrier 32 respectively contact the contact endpoints (not shown) at the top of the base 30. On the contrary, to achieve the same effect, flat contact endpoints may be disposed at the bottom of the transmitting circuit 38, and pin-type electronic signal connectors are disposed at the top of the base 30 correspondingly. The recess 34 guides the carrier 32 to the position, and thus each pin-type electronic signal connector is aligned with the corresponding contact endpoint.

To make the carrier 32 located at the predetermined position on the base 30 stably and make the transmitting circuit 38 effectively electrically communicate with the contact endpoint, the carrier 32 further has at least a first portion 33, and a second portion 35 is located at the top of the base 30 corresponding to the first portion 33. The first portion 33 and the second portion 35 are magnetically coupled to each other, and that is, at least one of the first portion 33 and the second portion 35 includes a magnet. As shown in FIG. 3, the second portion 35 is usually disposed in the recess 34, but it also may be disposed at other positions according to the structure of the carrier 32.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A detachable mounting assembly for a motherboard, comprising:
an electronic component;
a carrier carrying the electronic component and having a first portion;
a base located on the motherboard, wherein the base includes a recess located at a predetermined position corresponding to the carrier; and
a second portion disposed on the base, located in the recess and corresponding to the first portion, wherein the second portion and the first portion are magnetically coupled to each other.

2. The assembly according to claim 1, wherein the carrier further comprises an inserting structure cooperating with the recess to locate the carrier in the predetermined position.

3. The assembly according to claim 1, wherein the carrier further has a mounting structure for attaching and detaching the electronic component.

4. The assembly according to claim 1, wherein the carrier further has a transmitting circuit connected to the motherboard via the base to allow the electronic component to work via the transmitting circuit.

5. The assembly according to claim 1, wherein the carrier further comprises a thermal conducting mechanism for conducting the thermal generated by the electronic component.

6. The assembly according to claim 1, wherein the carrier further has a metal outer case covering the electronic component.

7. The assembly according to claim 1, wherein at least one of the first portion and the second portion has a magnet.

8. The assembly according to claim 1, wherein the electronic component is an integrated circuit (IC) component in a thin-type no-lead package state.

9. The assembly according to claim 1, wherein the electronic component is an interface card or a memory module.
